(19) United States
(12) Patent Application Publication
(10) Pub. No.: US 2019/0120389 A1
(43) Pub. Date: Apr. 25, 2019

(54) Fluid End Valve With Dual Inserts

(71) Applicant: Kerr Machine Co., Sulphur, OK (US)

(72) Inventors: Kelcy Jake Foster, Ardmore, OK (US); Mark S. Nowell, Ardmore, OK (US); Christopher Todd Barnett, Stratford, OK (US)

(21) Appl. No.: 16/169,663

(22) Filed: Oct. 24, 2018

Related U.S. Application Data
(60) Provisional application No. 62/576,443, filed on Oct. 24, 2017.

(51) Int. Cl. F16K 1/44; F16K 1/38; F16K 1/42; F16K 27/02; F04B 53/10

(52) U.S. Cl. CPC F16K 1/443; F16K 1/385; F04B 53/108; F16K 27/0254; F04B 53/1022; F16K 1/42

(57) ABSTRACT

A valve for use in a fluid end. The valve has a solid body with a sealing surface. The valve may move into a position wherein the valve when contacts a valve seat. When in contact, the sealing surfaces prevent flow of fluid through the valve. The sealing surface has three regions. The outer region has an elastomeric seal insert disposed on the surface. The inner region has a shock absorbing insert disposed on the surface. Intermediate these inserts is a metallic surface for metal-to-metal sealing with the valve seat.

### FIELD

The invention is directed generally to valve sealing surfaces for use with pump fluid ends.

### SUMMARY OF THE INVENTION

The invention is directed to a valve assembly. The valve assembly is disposed within a bore having a center axis and a tapered wall disposed at an angle relative to the center axis. The valve assembly comprises a valve body. The valve body is characterized by a strike face. The strike face is complementary to the tapered wall. The valve body comprises a first insert disposed at an outer periphery of the strike face and a second insert disposed on the strike face and spaced apart from the first insert. The first insert and second insert are each composed of a different material than the strike face.

In another embodiment the invention is directed to a valve comprising a body. The body has at least one sealing surface. The sealing surface is characterized by an annular outer section, an annular inner section, and an intermediate metallic portion disposed between the annular outer section and the annular inner section. The annular outer section has an elastomeric sealing insert disposed thereon. The annular inner section has a shock absorbing insert disposed thereon.

### BRIEF DESCRIPTION OF THE DRAWINGS

FIG. 1 is an exploded perspective view of a fluid end.

FIG. 2 is a sectional side view of the fluid end of FIG. 1 along section A-A.

FIG. 3 is a bottom side perspective of a prior art valve body.

FIG. 4 is a bottom side perspective view of the fluid end valve body of the present invention.

FIG. 5 is a side view of the fluid end valve body of FIG. 4.

FIG. 6 is a cutaway sectional side view of a fluid end bore with the valve body of FIG. 4 disposed therein.

### DETAILED DESCRIPTION

Fluid end assemblies are typically used in oil and gas operations to deliver highly pressurized corrosive and/or abrasive fluids to piping leading to the wellbore.

The assemblies are typically attached to power ends run by engines. The power ends reciprocate plungers within the assemblies to pump fluid throughout the fluid end. Fluid may be pumped through the fluid end at pressures that range from 5,000-15,000 pounds per square inch (psi). Fluid used in high pressure hydraulic fracturing operations is typically pumped through the fluid end at a minimum of 8,000 psi; however, fluid will normally be pumped through the fluid end at pressures around 10,000-15,000 psi during such operations, with spikes up to 22,500 psi.

This increase in maximum pressure causes failures in components not seen at lower pressures. Typical failures now include the failure of valves due to erosion of the valve sealing face which is accelerated by the large closing forces of the valve sealing face against the valve seat. While this failure mode is expected, the higher pressures are decreasing valve life to unacceptable levels. When the valve sealing face fails leakage occurs around the component. Leakage reduces the maximum pressure and flow capabilities of the system.

Efforts to eliminate the erosion of the valve sealing face have included hardening the valve sealing face in the same manner as the valve seat is hardened. The mating hardened surfaces provide an improved seal and allow the system to operate as desired. However, the impact of the hardened valve sealing face against the valve seat increases the erosion rate of both the valve sealing face and the valve seat sealing face due to the closing force associated with the fluid forced in and out of the fluid end by a reciprocating plunger. This failure occurs in an unacceptably short valve life before repair or replacement of the valve and/or the valve seat is required.

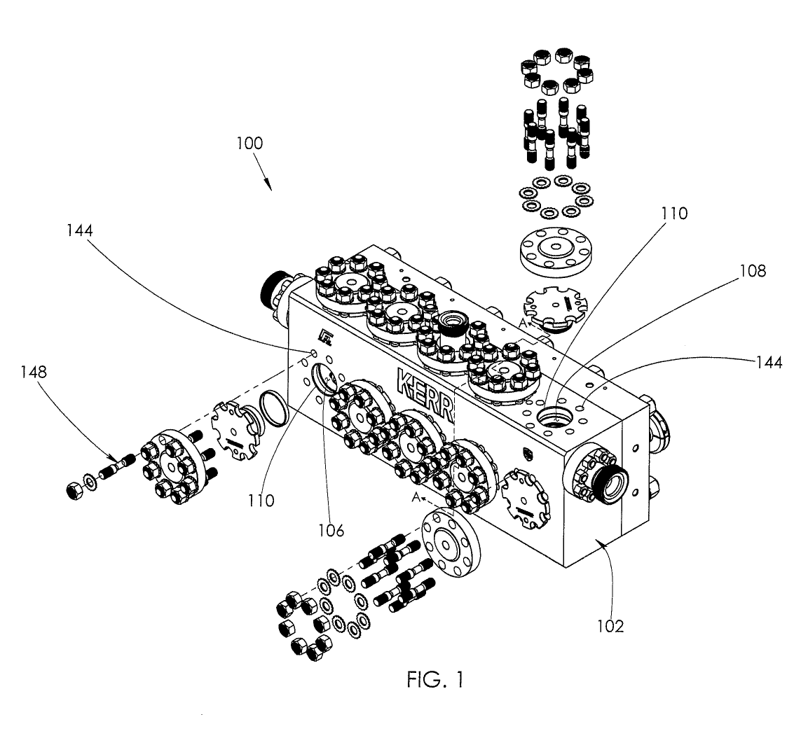

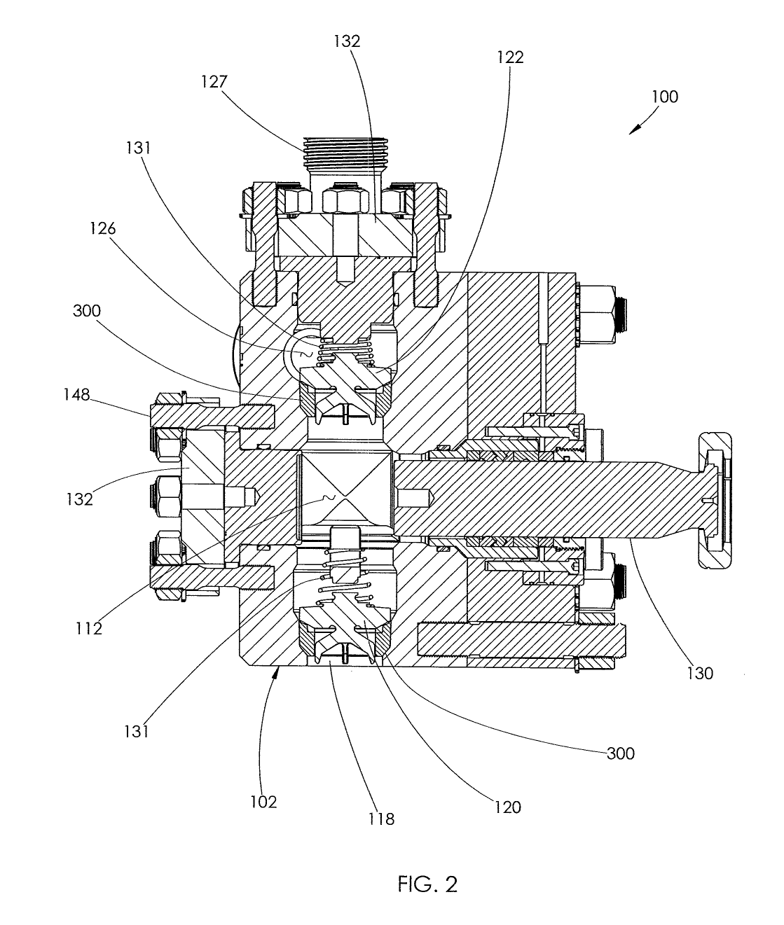

With reference to FIGS. 1 and 2, a fluid end 100 is shown. The fluid end 100 comprises a fluid end body 102 having a plurality of first and second bores 106, 108 formed adjacent one another therein, as shown in FIG. 1. Preferably, the number of first bores 106 equals the number of second bores 108. More preferably, each first bore 106 intersects its paired second bore 108 within the fluid end body 102 to form an internal chamber 112, as shown in FIG. 2.

FIG. 1 shows five first and second bores 106, 108. In alternative embodiments, the number of sets of paired first and second bores in the fluid end body may be greater than five, or less than five.

Each bore of each set of paired bores 106 and 108 terminates in a corresponding opening 110. The bores 106 and 108 and openings 110 exist in one-to-one relationship. A plurality of internally threaded openings 144 may be formed in the body 102 and uniformly spaced around each bore opening 110, as shown in FIG. 1, to accommodate pins 148 and retainers 132 for closing the bore openings 110.

With reference to FIG. 2, each second bore 108 may have an intake opening 118 formed proximate the bottom end of the fluid end body 102. Each intake opening 118 is connected in one-to-one relationship to a corresponding coupler or pipe. These couplers or pipes are fed from a single common piping system (not shown).

A pair of valves 120 and 122 are positioned within each second bore 108. The valves 120, 122 route fluid flow within the body 102. The intake valve 120 blocks fluid backflow through the intake opening 118. The discharge valve 122 regulates fluid through one or more discharge openings 126. A plurality of couplers 127 may be attached to each discharge opening 126 for connection to a piping system (not shown).

Each valve 120, 122 opens and closes due to movement of fluid within the internal chamber 112. A plunger 130 is provided within the first bore 106. As the plunger 130 retracts, the discharge valve 122 closes and the intake valve 120 opens, pulling fluid into the internal chamber 112. As the plunger 130 is advanced into the first bore 106, the intake valve 120 is closed and the discharge valve 122 opens, expelling fluid from the internal chamber 112. As shown in FIG. 2, the discharge valve 122 and intake valve 120 are both closed.

A coil spring 131 is disposed on each valve 120, 122 to center the valve and maintain its placement within the second bore 108. The coil spring 131 may also bias the valves 120, 122 in a closed position. A valve seat 300 is provided with each valve 120, 122 such that repeated impacts occur between the valve and valve seat, rather than the fluid end body 102.

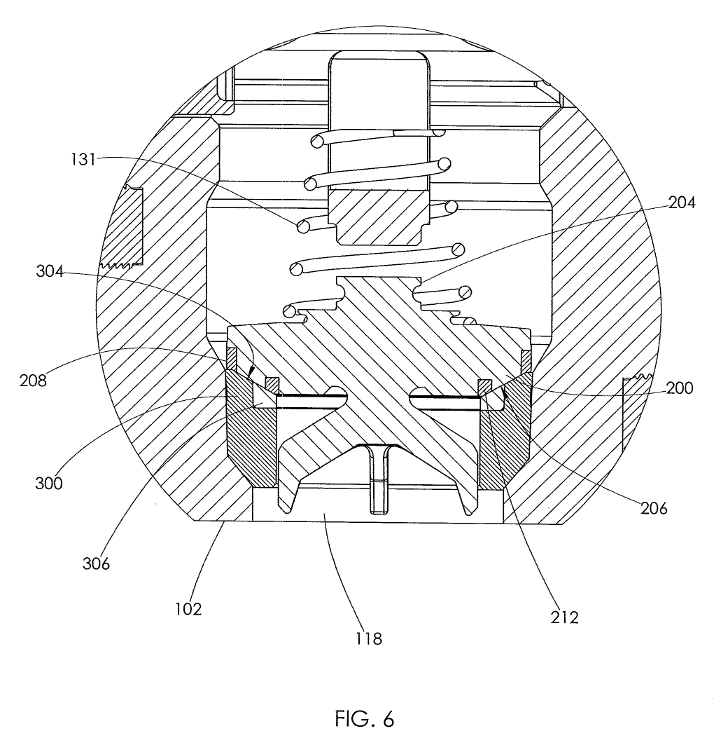

The valve seat 300 is disposed within the second bore 108 and seated against its wall. The valve seat 300 comprises a tapered strike face 304 (FIG. 6). The tapered strike face 304 may be hardened, or include a hardened insert 306 to provide durability necessary due to repeated strikes from each valve 120, 122.

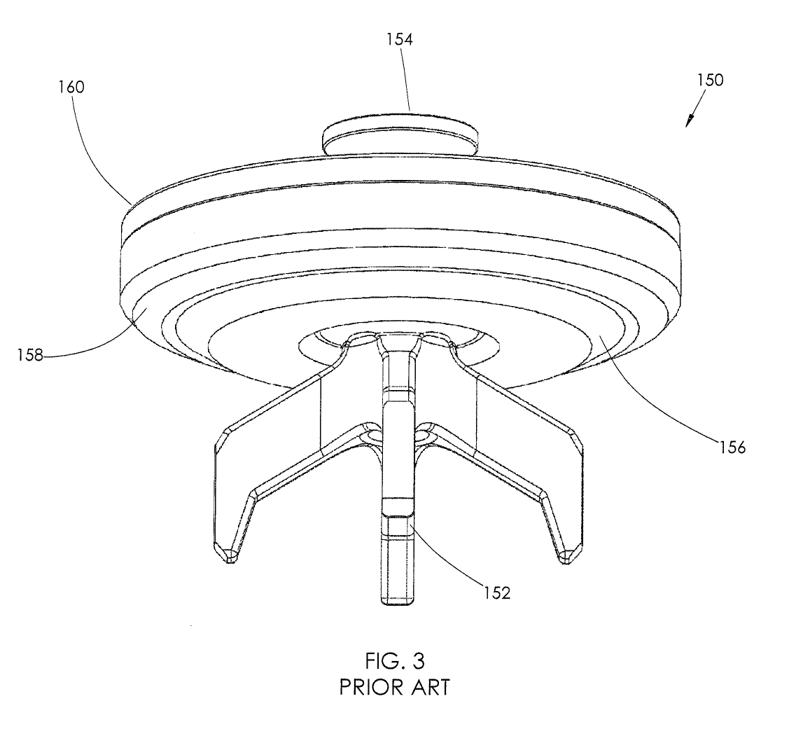

With reference to FIG. 3, a prior art valve 150 is shown. Such a valve body 150 may be used as either the intake valve 120 or discharge valve 122.

The valve 150 has a valve body 160 and an alignment structure 152 to assist in maintaining proper valve 150 orientation to the seat 300 (FIG. 2) when in operation and is well known in the art. Protrusion 154 centers the coil spring 131 (FIG. 2). When the valve 150 is closed, a valve sealing surface 156 and valve insert 158 contact the valve seat sealing surface (not shown) stopping fluid flow.

The valve sealing surface 156 is hardened by a post manufacturing process, such as nitriding or flame hardening, or is manufactured from a hard material such as carbide. It is advantageous to have the hardened valve sealing surface 156 to minimize erosion.

Valve insert 158 can be made of any of a number of durable elastomeric materials well known in the art. The elastomeric material may be polyethylene, nitryl rubber, nitrile rubber, or a similar material. Valve insert 158 may be applied to the valve body 160 and may be permanently attached or replaceable. The purpose of valve insert 158 is to provide more sealing capability for the valve 150. While the primary sealing is accomplished by the metal to metal contact of the valve sealing surface 156 to the valve seat 300 sealing surface, it is advantageous to have the elastomeric material encapsulate and seal around any solids trapped between the valve insert 158 and the seat sealing surface.

Once the valve insert 158 deforms, or compresses, the valve sealing surface 156 contacts the seat sealing surface and stops moving. Erosion occurs with each cycle due to the impact of the valve sealing surface 156 on the seat sealing surface.

While the valve insert 158 does contact the seat sealing surface first, it is not designed to reduce the impact force of the valve sealing surface 156 against the seat sealing surface, any reduction of the impact force is incidental. The valve insert 158 instead deforms to provide a backup, or secondary, seal for the valve sealing surface 156. In practice, the elastomeric material used for the valve insert 158 retains the deformation over time and loses the ability to provide any reduction of impact force. This loss of memory causes the valve sealing surface 156 to apply the full force of impact on the seat sealing surface further increasing the erosion rate until the two surfaces erode to the point of valve 150 failure due to the lack of sealing.

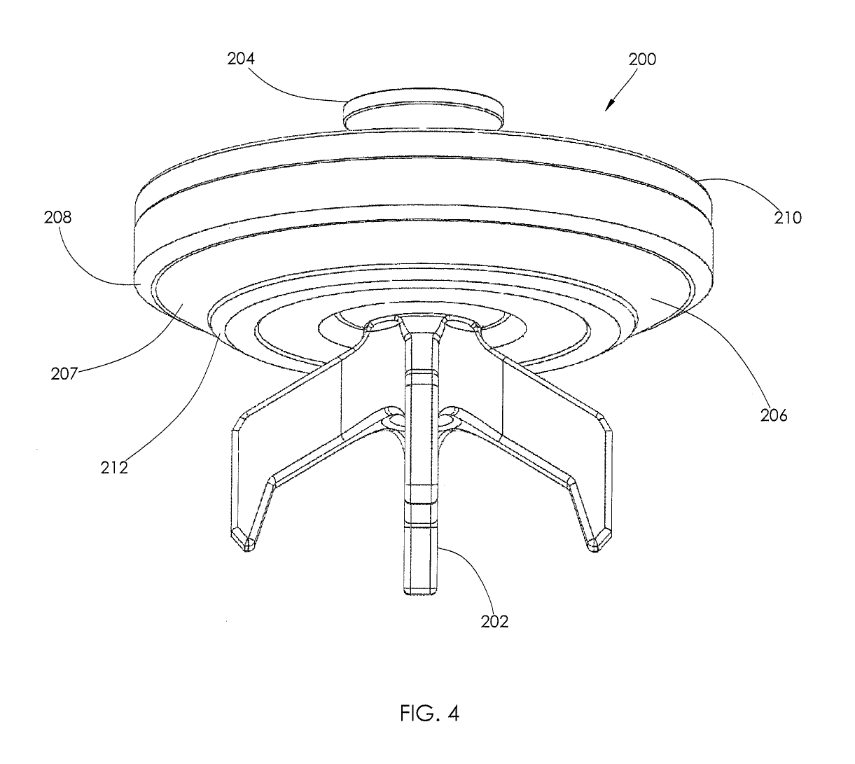

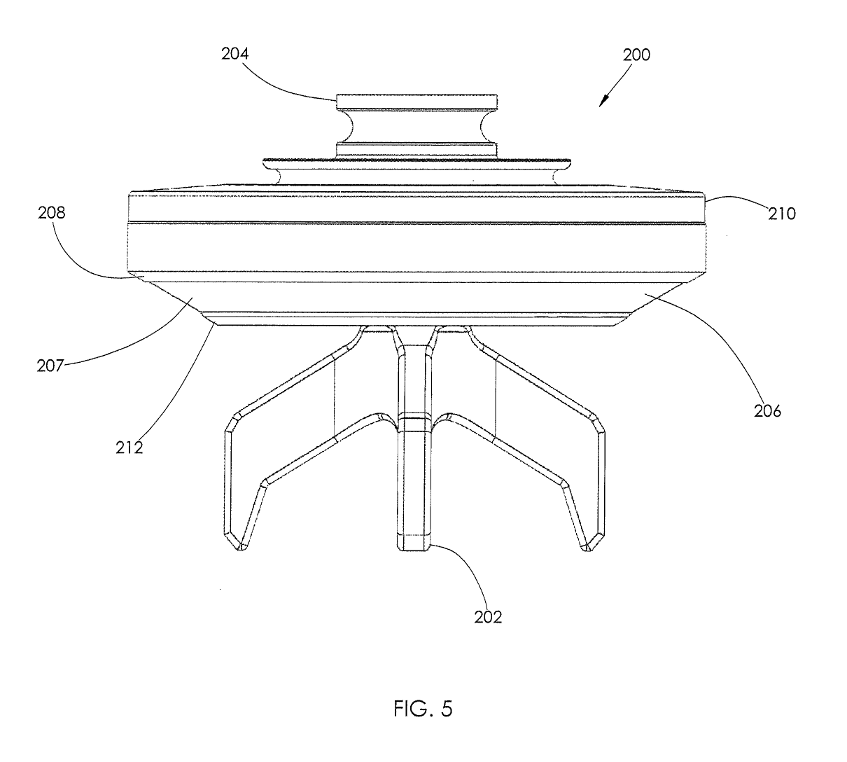

With reference to FIGS. 4-6, an improved valve 200 is shown. The improved valve 200 may be used as either the intake valve 120 or the discharge valve 122.

The valve 200 has alignment structure 202 to assist in maintaining proper valve 200 orientation to the seat 300, when in operation. A protrusion 204 disposed on the valve 200 opposite the alignment structure 202 to provide support for the coil spring 131 (FIG. 2). The valve 200 comprises a valve sealing surface 206 with an outer insert 208 and an inner insert 212 disposed thereon.

When the valve 200 is closed by the spring 131, the valve sealing surface 206, outer valve insert 208, and inner valve insert 212 contact the seat sealing surface 304 stopping fluid flow.

Valve sealing surface 206 may be hardened by a post manufacturing process, such as nitriding or flame hardening, or is manufactured from a hard material such as carbide. It is advantageous to have the hardened valve sealing surface 206 to minimize erosion providing the valve 200 does not fail prematurely. The area of the valve sealing surface 206 is larger than that of typical metal to metal seal valves, such as the previously attempted solution described above. The larger surface area is to reduce the amount of impact force per unit area imparted to the two sealing surfaces. If the closing force is the same and the surface area is increased then the amount of force per unit area is decreased which reduces the amount of erosion caused by the impact force.

The outer valve insert 208 is disposed on the sealing surface 206 along its outer edge, at a transition between the sealing surface 206 and a side wall. Outer valve insert 208 can be made of any of a number of elastomeric materials well known in the art. The specific material is selected based on the sealing qualities of the material in the fluid being controlled. Polyurethane, polyethylene, and rubber compounds may be advantageous. As with valve 150 and insert 158, the outer valve insert 208 provides sealing capability for the valve 200.

While the primary sealing is accomplished by the metal to metal contact of the valve sealing surface 206 to the seat sealing surface 304, it is advantageous to have the elastomeric material encapsulate and seal around any solids trapped between the outer valve insert 208 and the seat sealing surface 304.

The inner valve insert 212 is disposed at an inner and lower extremity of the valve sealing surface 206. The inner valve insert 212 should be placed such that its radius is approximately the inner diameter of the seat sealing surface 304. An exposed portion 207 of the valve sealing surface 206 is disposed intermediate the inner valve insert 212 and the outer valve insert 208. It is this exposed portion 207 that performs the majority of the sealing function for the valve 200.

Inner valve insert 212 can be made of elastomeric materials that are suitable for the fluid being controlled, however the selection is based on energy absorption capacity and memory capability of the material not the sealing qualities. While elastomeric materials may accomplish this, a reinforced elastomer or molded urethane material may be preferable to increase energy absorption and insert 212 life.

The two inserts 208, 212 may be made of the same material if desired. If the same material is used for both inserts 208, 212 the design may be changed to account for the different purpose of each insert. Inner valve insert 212 will reduce the impact force between the valve sealing surface 206 and the seat sealing surface 304. Some sealing may occur at inner valve insert 212 as well, but its primary function is that of a shock absorber.

The sealing surface 206 fully conforms to a portion of an imaginary smooth surface that extends between a pair of parallel planes that respectively limit the upper and lower ends of the valve body. The surface separates interior and exterior regions. The inserts 208 and 212 project within the exterior region while the sealing surface 206 does not project within the exterior region.

As the valve body moves axially toward the seat during valve closure, the inserts 208 and 12 contact the seat sealing surface 304 before the sealing surface 206 does so. Preferably, the axial extent of insert 212 within the exterior region, relative to the sealing face 206, exceeds that of insert 208. The inner insert 212 thus contacts sealing surface 304 during closure of the valve before either the outer insert 208 or valve sealing surface 206.

Any valve that uses one or more hardened surfaces may be improved by reducing the impact force of the valve sealing surface against the seat sealing surface. For instance, the inner valve insert 212 may be made of any material that will absorb enough energy to reduce the impact force to a level that both reduces erosion on the sealing surface 206 to an acceptable rate and deforms or compresses enough to allow the exposed sealing surface 207 to contact the seat sealing surface 304.

Another embodiment may include forming the inner valve insert out of hardened material and placing a spring or any other energy absorbing component between it and the valve body, axially, to absorb the energy and allow the movement necessary to allow the hardened sealing surfaces to contact. Another embodiment may reverse the positions of the inner and outer inserts making the inner valve insert 212 the sealing insert and the outer insert 208 the energy absorption insert. Yet another embodiment may reverse the metal and elastomeric components with one central elastomeric component that is designed to absorb the necessary energy and the inner and outer rings being hardened metal.

This improvement allows hardened sealing surfaces to be used with the reduction of failure due to erosion. This provides for a longer service life of the valves, decreasing maintenance costs and increasing operating times.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A valve assembly disposed within a bore having a center axis and a tapered wall disposed at a non-zero angle relative to the center axis, the valve assembly comprising:
a valve body having spaced inner and outer peripheries, the valve body characterized by a strike face having a shape complementary to the tapered wall, the valve body comprising:
a first insert disposed at the outer periphery of the strike face; and
a second insert disposed at the inner periphery of the strike face;
wherein the first insert and second insert are each composed of a different material than the strike face.

2. The valve assembly of claim 1 in which a valve seat is disposed in the bore and forms a portion of the tapered wall.

3. The valve assembly of claim 1, defining an imaginary smooth surface in which the smooth surface:
extends axially between parallel planes limiting the upper and lower ends of the valve body;
fully conforms to the strike face; and
separates exterior and interior regions;
wherein the inserts project within the exterior region and the strike face does not project within that region.

4. The valve assembly of claim 3 in which the imaginary smooth surface is a conical frustum.

5. The valve assembly of claim 3 in which the axial extent of the second insert within the exterior region, relative to the sealing face, exceeds that of the first insert.

6. The valve assembly of claim 1 in which the first insert and the second insert extend in a first direction from the strike face of the valve body, wherein the second insert has a greater axial extent than the first insert.

7. The valve assembly of claim 1 in which the first insert and the second insert are composed of different materials.

8. A fluid end comprising:
a unitary body having a first bore and a second bore, wherein the first bore and the second bore intersect at an internal chamber;
a fluid inlet in communication with the second bore;
a fluid discharge in communication with the second bore;
an intake valve comprising the valve assembly of claim 1, disposed in the second bore between the fluid inlet and the internal chamber; and
a discharge valve comprising the valve assembly of claim 1, disposed in the second bore between the fluid discharge and the internal chamber.

9. The fluid end of claim 8 further comprising a plunger disposed within the first bore.

10. A valve comprising:
a body comprising:
an annular outer section at least partially formed from an elastomeric material;
an annular inner section at least partially formed from a shock-absorbing material; and
an intermediate metallic portion disposed between the annular outer section and the annular inner section.

11. The valve of claim 10 wherein the elastomeric material and the shock absorbing material are the same material.

12. The valve of claim 10 wherein the intermediate metallic portion is nitrided.

13. The valve of claim 10 defining an imaginary smooth surface in which the smooth surface:
extends axially between parallel planes limiting the upper and lower ends of the body;
fully conforms to the intermediate metallic portion; and
separates exterior and interior regions;
wherein the annular outer section and annular inner section project within the exterior region and the intermediate metallic portion does not project within that region.

14. The valve of claim 13 in which the annular inner section projects axially further within the exterior region than the annular outer section.

15. The valve of claim 10 in which the shock absorbing material is elastomeric.

16. The valve of claim 10 further comprising a seat having an internally disposed fluid passage, wherein the seat defines a sealing surface disposed at a non-zero angle relative to a center line of the fluid passage.

17. The valve of claim 16 in which the body is movable from a first position to a second position relative to the seat, in which the first position is characterized by the sealing surface of the body contacting and being in sealing engagement with the sealing surface of the seat.

18. A fluid end comprising:
a body having a bore disposed therein; and
the valve of claim 17 disposed within the bore such that the seat is fixed in position within the bore.
